(19) United States
(12) Patent Application Publication
(10) Pub. No.: US 2014/0164876 A1
(43) Pub. Date: Jun. 12, 2014

(54) MODULATION CODING OF PARITY BITS GENERATED USING AN ERROR-CORRECTION CODE

(71) Applicant: LSI Corporation, San Jose, CA (US)

(72) Inventors: Elyar Eldarovich Gasanov, Moscow (RU); Pavel Anatolyevich Panteleev, Moscow (RU); Yurii Sergeevich Shutkin, Moscow (RU); Andrey Pavlovich Sokolov, Moscow (RU); Ilya Vladimirovich Neznanov, Moscow (RU)

(21) Appl. No.: 13/945,080

(22) Filed: Jul. 18, 2013

(30) Foreign Application Priority Data
Dec. 6, 2012 (RU) 2012152710

(51) Int. Cl. G06F 11/10

(52) U.S. Cl. CPC G06F 11/10
USPC 714/769

(57) ABSTRACT

A communication system, such as a magnetic recording channel, configured to apply modulation coding to parity bits of a block error-correction code. An embodiment of the communication system may have a transmitter having two different modulation encoders, one configured to apply a first modulation code to information bits and the other configured to apply a second modulation code to the parity bits that have been generated from the information bits using a block error-correction code. Alternatively or in addition, an embodiment of the communication system may have a receiver that incorporates a soft modulation codec configured to use the second modulation code in the log-likelihood-ratio space to enable decoding iterations between a sequence detector and a parity-check decoder.

### FIELD

The present invention relates to communication and data-storage equipment and, more specifically but not exclusively, to joint use of modulation and error-correction coding.

### BACKGROUND

In a magnetic recording channel, an error-correction code, such as a low-density parity-check (LDPC) code, is sometimes used together with a modulation code to improve the channel's performance characteristics. Two modulation codes often used in magnetic recording channels are a run-length-limited (RLL) code and a maximum-transition-run (MTR) code. An RLL code limits the number of consecutive zeros stored in a magnetic track to a specified maximum number, which can help the magnetic recording channel to reliably generate a clock signal using a phase-lock loop. An MTR code limits the number of consecutive ones in a magnetic track to a specified maximum number, which can help to alleviate the adverse effects of inter-symbol interference. However, one problem with a conventional magnetic recording channel is that parity bits of the error-correction code are not subjected to MTR or RLL coding, which causes the recorded data to sometimes have undesirable bit sequences despite the use of MTR or RLL coding on other parts of the codeword(s). The fact that a practical modulation codec for parity bits of a block error-correction code has not been sufficiently developed yet is at least partially responsible for this problem.

### SUMMARY

Disclosed herein are various embodiments of a communication system, such as a magnetic recording channel, configured to apply modulation coding to parity bits of an error-correction code. An embodiment of the communication system may have a transmitter having two different modulation encoders, one configured to apply a first modulation code to information bits and the other configured to apply a second modulation code to the parity bits that have been generated from the information bits using an error-correction code.

Alternatively or in addition, an embodiment of the communication system may have a receiver that incorporates a soft modulation codec configured to use the second modulation code in the log-likelihood-ratio space to enable decoding iterations between a sequence detector and a parity-check decoder.

### DESCRIPTION OF THE FIGURES

Other embodiments of the disclosure will become more fully apparent from the following detailed description and the accompanying drawings, in which:

FIG. 1 shows a block diagram of a transmitter according to an embodiment of the disclosure;

FIG. 2 shows a block diagram of a receiver according to an embodiment of the disclosure;

FIG. 3 shows a block diagram of a detector/codec module that can be used in the receiver of FIG. 2 according to an embodiment of the disclosure;

FIG. 4 shows a flowchart of a signal-processing method that can be implemented in the detector/codec module of FIG. 3 according to an embodiment of the disclosure; and

FIG. 5 illustrates a possible structure of a log-likelihood-ratio set corresponding to a modulation-encoded bit sequence processed in the detector/codec module shown in FIG. 3 according to an embodiment of the disclosure.

### DETAILED DESCRIPTION

The following acronyms/abbreviations are used in the description of various embodiments and/or in the accompanying drawings:
LDPC Low-Density Parity Check;
LLR Log-Likelihood Ratio;
MAP Maximum A Posteriori;
MLSE Maximum-Likelihood Sequence Estimation;
MTR Maximum Transition Run;
NRZ Non-Return to Zero;
NRZI Non-Return-to-Zero Inverse; and
RLL Run-Length Limited.

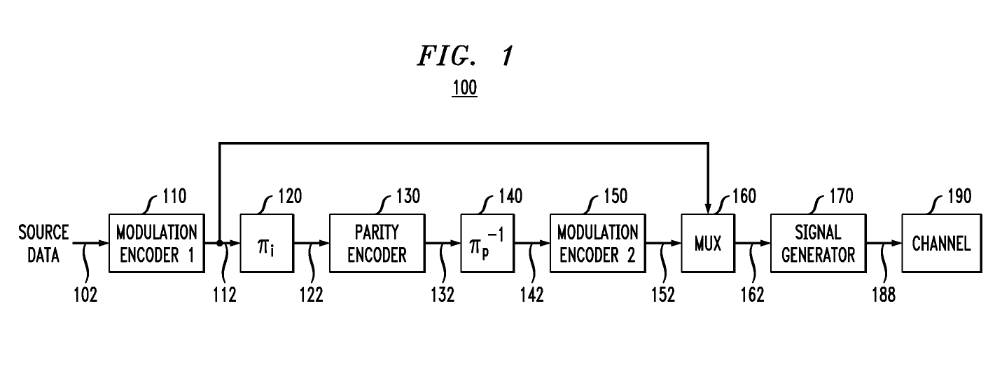

FIG. 1 shows a block diagram of a transmitter 100 according to an embodiment of the disclosure. Transmitter 100 is configured to (i) receive an input data stream 102, (ii) apply modulation and parity-check coding to transform the input data stream into an output communication signal 188, and (iii) apply the output communication signal to a communication channel 190. Note that communication channel 190 is not part of transmitter 100. In a possible embodiment, communication channel 190 can be a part of a magnetic memory system. In an alternative embodiment, communication channel 190 can be an optical, wireless, or wireline data-transport link. For illustration purposes, the subsequent description is given in reference to communication channel 190 being a part of a magnetic memory system. However, contemplated embodiments are not so limited. From the provided description, one of ordinary skill in the art will be able to make and use transmitters and receivers suitable for being coupled to various alternative embodiments of communication channel 190.

Input data stream 102 comprises a sequence of bits, often referred to as original information bits. A first modulation encoder 110, to which input data stream 102 is directed in transmitter 100, is configured to apply a first (outer) modulation code to the sequence of original information bits. The result of this application is a data stream 112, copies of which are applied to an interleaver 120 and a multiplexer (MUX) 160. Data stream 112 satisfies the constraints of the first modulation code and typically carries more bits than input data stream 102. For example, an original information word in input data stream 102 might be 8-bit long, while a corresponding modulation-encoded word in data stream 112 might be 9-bit long. In this example, the first modulation code has a rate of 8/9. In various embodiments, the first modulation code can be an RLL code or an MTR code.

Interleaver 120 is configured to apply a first interleaving operation (πᵢ) to data stream 112, thereby generating a data stream 122. More specifically, the first interleaving operation changes the order of bits in a modulation-encoded word without changing the number of bits in it. Interleaver 120 then applies data stream 122 to a parity encoder 130.

Based on data stream 122, parity encoder 130 generates a parity-bit stream 132. More specifically, based on a word from data stream 132, parity encoder 130 generates a corresponding set of parity bits. For example, in one possible embodiment, parity encoder 130 can be configured to use a systematic LDPC code, wherein a generator matrix (G) consists of an identity sub-matrix (I) and a non-systematic parity-bit generator sub-matrix (P) concatenated together in the form of G=[I P]. In this embodiment, for each interleaved modulation-encoded word cᵢ from data stream 132, parity encoder 130 generates set pᵢ of parity bits by applying non-systematic parity-bit generator sub-matrix P to cᵢ. Different sets pᵢ corresponding to different interleaved modulation-encoded words cᵢ are then concatenated at the output of parity encoder 130 to form data stream 132. Note that interleaved modulation-encoded words cᵢ of data stream 122 are not included into data stream 132.

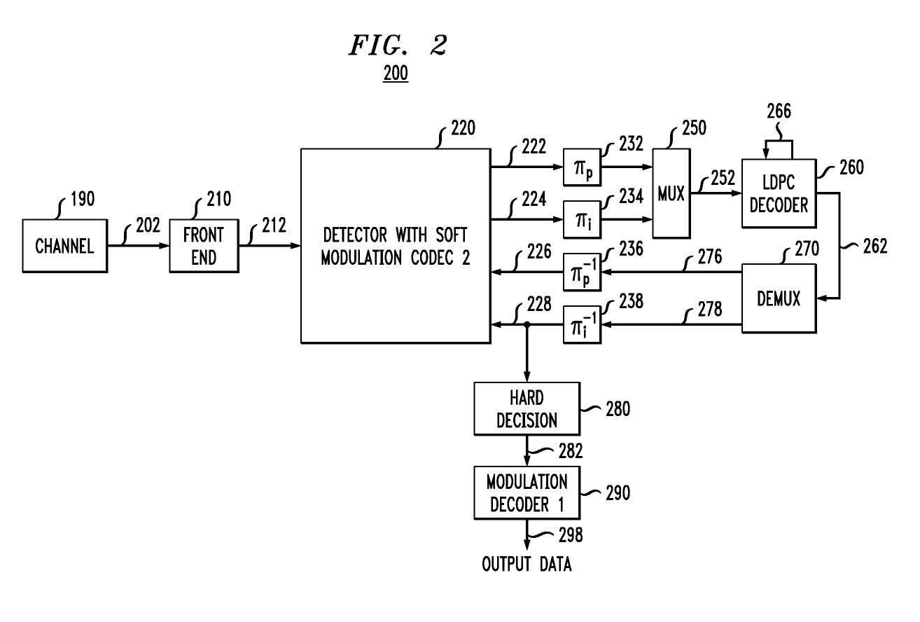

A de-interleaver 140 is configured to apply a de-interleaving operation (πₚ⁻¹) to each parity-bit set pᵢ of data stream 132. The resulting de-interleaved parity-bit sets are concatenated to generate a data stream 142. Data stream 142 is then applied to a second modulation encoder 150. Note that de-interleaving operation πₚ⁻¹ is an inverse of a second interleaving operation (πₚ) used at a corresponding receiver, e.g., receiver 200 of FIG. 2. De-interleaving operation πₚ⁻¹ is also related to interleaving operation πᵢ applied in interleaver 120 in that it causes the bit order in data stream 142 to be independent of the bit reordering performed in interleaver 120. In other words, de-interleaving operation πₚ⁻¹ reverses (cancels) the effect of interleaving operation πᵢ on data stream 142.

One of ordinary skill in the art will appreciate that each of the terms “interleaving” and “de-interleaving” refers to an operation that changes the order of bits in a bit sequence in a accordance with a specified algorithm. Each interleaving operation it has a corresponding de-interleaving operation π⁻¹ that undoes the change of the bit order such that π⁻¹=π⁻¹ π=1 (where “1” denotes an identity permutation, which maps each element of the sequence to itself in the original order), and the designations of these two operations as an “interleaving operation” and a “de-interleaving operation” are relative. For example, let us assume that two interleaving operations π₁ and π₂ satisfy the following condition: it π₂=π₂π₁=1. Then, the relative nature of the designations means that each of operations π₁ and π₂ can be referred to as “interleaving” or “de-interleaving.” More specifically, when operation π₁ is referred to as “interleaving,” operation π₂ is referred to as “de-interleaving.” Alternatively, when operation π₂ is referred to as “interleaving,” operation π₁ is referred to as “de-interleaving.”

In an alternative embodiment, interleaver 120 and de-interleaver 140 are optional and can both be omitted in transmitter 100.

Encoder 150 is configured to apply a second (inner) modulation code to each of the de-interleaved parity-bit sets of data stream 142 to generate a data stream 152 having modulation-encoded, de-interleaved parity-bit sets. Each modulation-encoded, de-interleaved parity-bit set in data stream 152 satisfies the constraints of the second modulation code and is typically longer than the corresponding (unconstrained) de-interleaved parity-bit set in data stream 142. In one embodiment, the second modulation code can be an MTR code.

Multiplexer 160 is configured to multiplex data stream 112 and data stream 152 to generate a data stream 162 having codewords intended for transmission over channel 190 to a corresponding receiver, e.g., receiver 200 of FIG. 2. More specifically, multiplexer 160 is configured to generate each codeword for data stream 162 by concatenating a modulation-encoded word from data stream 112 and a corresponding modulation-encoded de-interleaved parity-bit set from data stream 152. The resulting parity/modulation-encoded codewords are concatenated to form data stream 162, which is then applied to a signal generator 170.

Signal generator 170 is configured to convert data stream 162 into output communication signal 188, which has a physical form suitable for application to channel 190. For example, in a non-return-to-zero-inverse (NRZI) magnetic-storage system, every digital “one” is represented by a magnetic-flux transition in a bit cell, and every digital “zero” is represented by a lack of a magnetic-flux transition in a bit cell. Accordingly, in this embodiment, signal generator 170 is configured to generate output communication signal 188 in a manner that induces, in the storage medium of channel 190, a magnetization reversal for every digital “one” in data stream 162 and a lack of magnetization reversal for every digital “zero” in the data stream. For alternative embodiments of channel 190, signal generator 170 can be similarly appropriately configured to generate other suitable physical forms of output communication signal 188.

FIG. 2 shows a block diagram of a receiver 200 according to an embodiment of the disclosure. Receiver 200 is illustratively shown as being configured to receive an input communication signal 202 from communication channel 190 and decode this signal to generate an output data stream 298. When input communication signal 202 corresponds to communication signal 188, in the absence of bit errors, output data stream 298 is a copy of data stream 102 (see FIG. 1). Note that communication channel 190 is not a part of receiver 200.

Receiver 200 has a front-end circuit 210 configured to receive communication signal 202 and convert this communication signal into an electrical digital signal 212 that is amenable to the subsequent digital-signal processing in the receiver. In one embodiment, front-end circuit 210 may include an analog-to-digital converter and a series of configurable filters, such as a continuous-time filter, a digital phase-lock loop, a waveform equalizer, and a noise-predictive finite-impulse-response equalizer (not explicitly shown in FIG. 2). The continuous-time filter operates to modify the frequency content of the digital signal generated by the analog-to-digital converter, e.g., to remove a dc component (if any) and attenuate certain frequencies dominated by noise or interference. The digital phase-lock loop operates to extract a clock signal that can then be used to more optimally sample communication signal 202 for processing. The waveform equalizer operates to adjust waveform shapes, e.g., to make them closer to optimal waveform shapes for which the downstream circuits are designed and/or calibrated. The noise-predictive finite-impulse-response equalizer operates to reduce the amount of data-dependent, correlated noise in the signal generated by the waveform equalizer.

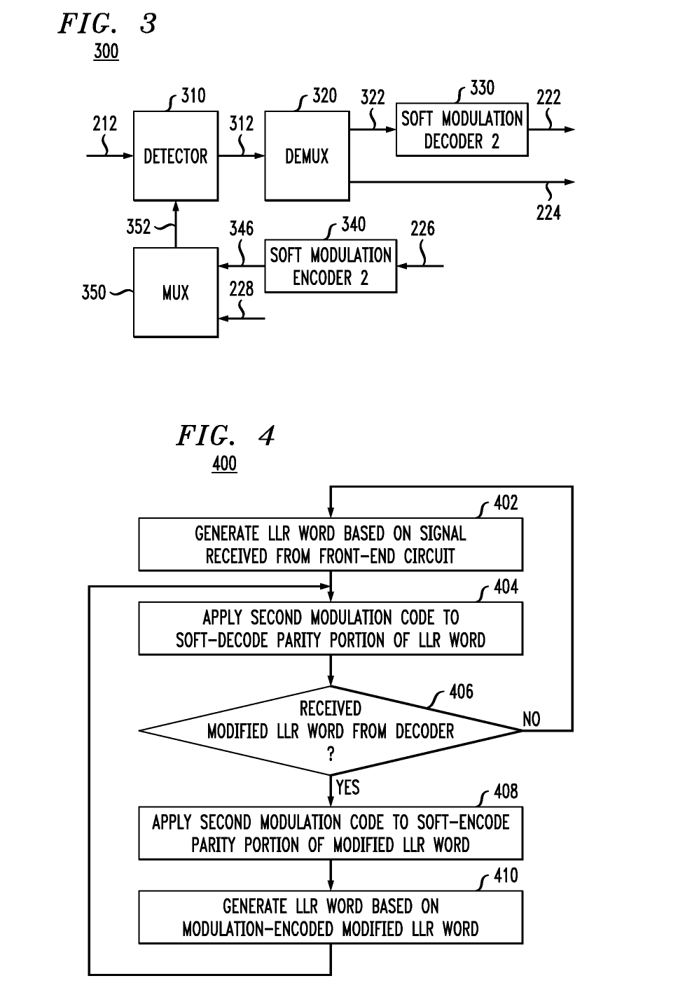

Digital signal 212 generated by front-end circuit 210 is applied to a detector/codec module 220 configured to convert this signal into sets 222 and 224 of log-likelihood-ratio (LLR) values. More specifically, module 220 has a sequence detector (not explicitly shown in FIG. 2) that implements maximum-likelihood sequence estimation (MLSE) using a suitable MLSE algorithm, such as a Viterbi-like algorithm. Module 220 also includes a modulation codec (not explicitly shown in FIG. 2) configured to use the second modulation code, which enables the sequence detector to take into account the modulation coding of parity bits implemented at the corresponding transmitter, such as in encoder 150 of transmitter 100 (FIG. 1). A more-detailed description of the processing implemented in module 220 is given below in reference to FIGS. 3 and 4.

An important feature of the modulation codec used in module 220 is that it is configured to operate on LLR values rather than on hard bit values, as is the case with conventional modulation codecs. As a result, LLR sets 222 and 224 generated by module 220 contain LLR values that represent the detector's confidence in the correctness of the estimated parity-encoded codewords after the modulation coding of parity bits has been taken into account. For each estimated parity-encoded codeword, LLR set 222 has LLR values representing the parity bits of the corresponding codeword, and LLR set 224 has LLR values representing the information bits of the codeword.

In a possible embodiment, an LLR value may comprise (i) a sign bit that represents the detector's best guess (hard decision) regarding the bit value encoded in signal 212 and (ii) one or more magnitude bits that represent the detector's confidence in the hard decision. For example, module 220 may be configured to output each LLR value as a five-bit value, where the most-significant bit is the sign bit and the four least-significant bits are the confidence bits. By way of example and without limitation, a five-bit LLR value of 00000 indicates a hard decision of 0 with minimum confidence, while a five-bit LLR value of 01111 indicates a hard decision of 0 with maximum confidence. Intermediate values (e.g., between 0000 and 1111) of confidence bits represent intermediate confidence levels. Similarly, a five-bit LLR value of 10001 indicates a hard decision of 1 with minimum confidence, while a five-bit LLR value of 11111 indicates a hard decision of 1 with maximum confidence, wherein the binary value of 10000 is unused. Other numbers of bits and other representations of confidence levels may alternatively be used as well.

Module 220 is coupled to a parity-check (e.g., LDPC) decoder 260 (i) via interleavers 232 and 234 and multiplexer 250 and (ii) via de-multiplexer 270, and de-interleavers 236 and 238. Interleavers 232 and 234 and multiplexer 250 are located in the feed-forward path from module 220 to decoder 260. De-multiplexer 270 and de-interleavers 236 and 238 are located in the feedback path from decoder 260 to module 220. Each of interleavers 232 and 234, multiplexer 250, de-multiplexer 270, and de-interleavers 236 and 238 is configured to operate on sequences of LLR values. This characteristic is different from the corresponding characteristic of interleaver 120, de-interleaver 140, and multiplexer 160 in transmitter 100 (FIG. 1), each of which is configured to operate on (hard) bit sequences. When receiver 200 is coupled to transmitter 100 (FIG. 1), interleavers 232 and 234, multiplexer 250, de-multiplexer 270, and de-interleavers 236 and 238 are configured to perform the following respective operations. Interleaver 232 is configured to perform interleaving operation πₚ, which is an inverse of de-interleaving operation πₚ⁻¹ performed by de-interleaver 140 in transmitter 100. Interleaver 234 is configured to perform interleaving operation πᵢ, which is the same interleaving operation as that performed by interleaver 120 in transmitter 100. De-interleaver 236 is configured to perform de-interleaving operation πₚ⁻¹, which is (i) the same de-interleaving operation as that performed by de-interleaver 140 in transmitter 100 and (ii) an inverse of interleaving operation πₚ performed by interleaver 232. De-interleaver 238 is configured to perform de-interleaving operation πᵢ⁻¹, which is (i) an inverse of interleaving operation πᵢ performed by interleaver 140 in transmitter 100 and (ii) an inverse of interleaving operation πᵢ performed by interleaver 234. Multiplexer 250 is configured to perform a multiplexing operation that is analogous to that performed by multiplexer 160 in transmitter 100. De-multiplexer 270 is configured to perform a de-multiplexing operation that is an inverse of the multiplexing operation performed by multiplexer 250.

Decoder 260 is configured to decode a sequence 252 of LLR values received from multiplexer 250 in a conventional manner, e.g., using one or more local iterations indicated in FIG. 2 by a looped arrow 266 and, if necessary, one or more global iterations with module 220 using the above-mentioned feedback path having de-multiplexer 270 and de-interleavers 236 and 238. More specifically, for each LLR word from sequence 252, decoder 260 first attempts to converge on a valid parity-encoded (e.g., LDPC) codeword using local iterations 266. Local iterations 266 can be based, e.g., on a suitable message-passing or belief-propagation algorithm. Any valid parity-encoded codeword is characterized in that all its parity checks defined by the code's parity-check matrix are satisfied (e.g., produce zeros). Therefore, the convergence of local iterations 266 on a valid parity-encoded codeword can be determined, e.g., by configuring decoder 260 to calculate parity checks after each of said local iterations.

If decoder 260 fails to converge on a valid parity-encoded codeword after a specified maximum number of local iterations 266, then the decoding processing in the decoder is temporarily halted, and a corresponding global iteration is initiated by directing the signal processing back to detector 220. More specifically, for an LLR word from sequence 252 to which decoder 260 has applied the decoding processing, the decoder generates a modified LLR word 262. Modified LLR word 262 differs from the corresponding initial LLR word from sequence 252, e.g., because some of the sign-bit values and/or some of the confidence values may have been changed in the course of local iterations 266.

After being de-multiplexed in de-multiplexer 270 and de-interleaved in de-interleavers 236 and 238, modified LLR word 262 is converted into the corresponding LLR sets 226 and 228, which are directed back to detector 220. More specifically, LLR set 226 has LLR values corresponding to the parity bits of the parity-encoded codeword; and LLR set 228 has LLR values corresponding to the information bits of the parity-encoded codeword. Based on LLR sets 226 and 228, detector 220 regenerates LLR sets 222 and 224 and feeds them forward to decoder 260 for a next decoding attempt using local iterations 266.

If decoder 260 converges on a valid parity-encoded codeword, then LLR word 262 contains LLR values, wherein the sign-bit values express that parity-encoded codeword. De-multiplexer 270 de-multiplexes LLR word 262 into the corresponding LLR sets 276 and 278. De-interleaver 238 then applies de-interleaving operation πᵢ⁻¹ to LLR set 278 to convert it into the corresponding LLR set 228. A hard-decision filter 280 then removes the magnitude bits from LLR set 228, thereby transforming said LLR set into the corresponding modulation-encoded codeword 282. Finally, a modulation decoder 290 decodes modulation-encoded word 282 to recover the corresponding original information word and outputs the recovered original information word as part of output data stream 298. Note that the modulation decoding performed in modulation decoder 290 uses the first modulation code and is an inverse of the modulation encoding applied to the information bits at the corresponding transmitter, such as the modulation encoding performed in modulation encoder 110 of transmitter 100 (FIG. 1).

FIG. 3 shows a block diagram of a detector/codec module 300 that can be used as module 220 (FIG. 2) according to an embodiment of the disclosure. For illustration purposes, module 300 is shown in FIG. 3 as being configured to receive digital signal 212 and LLR sets 226 and 228 and to generate LLR sets 222 and 224. When used in a circuit other than receiver 200, module 300 can be configured to receive/generate other appropriate signals.

Module 300 has a sequence detector 310 configured to receive digital signal 212 and convert it into a corresponding sequence of LLR words 312. In one embodiment, sequence detector 310 operates to (i) emulate signal distortions in the communication channel, such as communication channel 190; (ii) compare digital signal 212 with an anticipated distorted signal; and (iii) estimate the most likely transmitted bit sequence based on said comparison. Each LLR word 312 generated by sequence detector 310 contains LLR values that represent the detector's confidence in the correctness of the estimated bit sequence carried by the corresponding portion of digital signal 212.

Module 300 further has a de-multiplexer 320 configured to de-multiplex LLR word 312 into the corresponding LLR sets 322 and 224. LLR set 322 has LLR values representing the parity bits of the corresponding codeword. As already indicated above, LLR set 224 has LLR values representing the information bits of the codeword.

A soft modulation decoder 330 is configured to receive LLR set 322 from de-multiplexer 320 and apply to it soft modulation decoding using the second modulation code, e.g., as described below in reference to FIG. 4. As a result, soft modulation decoder 330 transforms LLR set 322 into a corresponding LLR set 222. Due to the nature of modulation decoding, LLR set 222 has fewer LLR values than LLR set 322. Note that soft modulation decoder 330 is configured to apply the second modulation code in the LLR space because the processing corresponding to the second modulation code is applied to LLR values (namely, LLR set 322) and the results of such processing are also LLR values (namely, LLR set 222). This feature of decoder 330 is different from the corresponding feature of a conventional modulation decoder because the latter decoder applies the processing corresponding to the modulation code to hard bits and the result of such processing is also hard bits. The term “soft” in the name of modulation decoder 330 indicates that this decoder operates in the LLR space, as explained above.

A soft modulation encoder 340 and a multiplexer 350 are parts of the feedback path from decoder 260 to detector 310. Soft modulation encoder 340 is configured to receive LLR set 226 and apply to it soft modulation encoding using the second modulation code, e.g., as described below in reference to FIG. 4. As a result, soft modulation encoder 340 transforms LLR set 226 into a corresponding LLR set 346. Due to the nature of modulation encoding, LLR set 346 has more LLR values than LLR set 226. As already indicated above, LLR set 226 has LLR values representing the parity bits of the codeword. Similar to soft modulation decoder 330, soft modulation encoder 340 is configured to apply the second modulation code in the LLR space.

Multiplexer 350 is configured to multiplex LLR sets 346 and 228 to generate a corresponding LLR word 352. As already indicated above, LLR set 228 has LLR values representing the information bits of the corresponding codeword. Based on LLR word 352, sequence detector 310 regenerates the corresponding LLR word 312 and sends the regenerated LLR word down the feed-forward path toward decoder 260 for a next decoding attempt.

FIG. 4 shows a flowchart of a signal-processing method 400 that can be implemented in detector/codec module 300 according to an embodiment of the disclosure. For illustration purposes, method 400 is described in reference to (i) a non-return-to-zero (NRZ) magnetic-storage system and (ii) the second modulation code being an MTR(r) code, where r is a positive integer representing the code's constraint. From the provided description, one of ordinary skill in the art will be able to make and use alternative embodiments, in which (i) the signals received by module 300 correspond to a communication channel different from that of an NRZ magnetic-storage system and (ii) the second modulation code is different from an MTR(r) code.

In an NRZ magnetic-storage system, “zeros” and “ones” are represented by opposite directions of the magnetization. Flux reversals occur only at mid-cells or, in some embodiments, at cell boundaries. An absence of a flux reversal means that the next cell stores the same bit value as the preceding cell.

In one embodiment, an MTR(r) code operates as follows. To encode a bit set of length p, the bit set is first partitioned into subsets of length r, where r<p. Then, each r-bit subset is replaced by a corresponding (r+1)-bit subset. For an NRZ magnetic-storage system, the (r+1)-bit subset differs from the source r-bit subset only in the extra (r+1)-th bit, which is appended to the r-bit subset and is a duplicate of the r-th bit from the r-bit subset. In mathematical terms, if the initial p-bit set is (a₁, a₂, . . . , aₚ), then the corresponding MTR(r)-encoded bit set is (a₁, a₂, . . . , aᵣ, aᵣ, aᵣ₊₁, aᵣ₊₂, . . . , a₂ᵣ, a₂ᵣ, a₂ᵣ₊₁, . . . , aₚ).

At step 402 of method 400, sequence detector 310 is configured to generate an LLR word 312 based on the corresponding segment of digital signal 212 (also see FIG. 3). The generated LLR word 312 is a sequence of LLR values that represents the corresponding parity/modulation encoded codeword, such as one of the codewords in data stream 162 (FIG. 1). In various embodiments, step 402 can be implemented using suitable variants of a maximum a posteriori (MAP) algorithm, such as one of those disclosed in (1) C. Berrou, A. Glavieux, and P. Thitimajshima, “Near Shannon Limit Error-Correcting Coding and Decoding: Turbo Codes,” Proc. IEEE Int. Conf. Communications (ICC'93), May 1993, pp. 1064-1070; (2) R. W. Chang and J. C. Hancock, “On Receiver Structures for Channels Having Memory,” IEEE Trans. Inform. Theory, vol. IT-12, pp. 463-468, October 1966; (3) L. R. Bahl, J. Cocke, F. Jelinek, and J. Raviv, “Optimal Decoding of Linear Codes for Minimizing Symbol Error Rate,” IEEE Trans. Inform. Theory, vol. IT-20, pp. 284-287, March 1974; and (4) J. Hagenauer, E. Offer, and L. Papke, “Iterative Decoding of Binary Block and Convolutional Codes,” IEEE Trans. Inform. Theory, vol. 42, pp. 429-445, March 1996, all of which are incorporated herein by reference in their entirety. In some embodiments, the MAP algorithm can be implemented in the logarithmic domain, e.g., as disclosed in (i) A. J. Viterbi, “An Intuitive Justification and a Simplified Implementation of the MAP decoder for Convolutional Codes,” IEEE J. Select. Areas Commun., vol. 16, pp. 260-264, February 1998; (ii) N. G. Kingsbury and P. J. W. Rayner, “Digital Filtering Using Logarithmic Arithmetic,” Electron. Letters, vol. 7, no. 2, pp. 56-58, January 1971; and (iii) J. A. Erfanian and S. Pasupathy, “Low-Complexity Parallel-Structure Symbol-by-Symbol Detection for ISI Channels,” in Proc. IEEE Pacific Rim Conf. Communications, Computers and Signal Processing, Jun. 1-2, 1989, pp. 350-353, all of which are also incorporated herein by reference in their entirety.

At step 404, decoder 330 is configured to apply soft MTR decoding, using the MTR(r) code, to the parity portion of the LLR word 312 generated at step 402. In the description of FIG. 3, said parity portion is referred to as LLR set 322, and the corresponding LLR set generated after the soft MTR decoding is LLR set 222. In various alternative embodiments, the soft MTR decoding of step 404 can be applied to an LLR word corresponding to a binary codeword or to an LLR word corresponding to a non-binary codeword. As known in the art, a non-binary codeword consists of symbols selected from a constellation comprising a plurality of (usually more than two) symbols. For purposes of generalization, a binary codeword can be considered to be a specific case of a non-binary codeword generated using a constellation consisting of only two symbols, e.g., a binary “one” and a binary “zero.”

For binary codewords, the soft MTR decoding of step 404 can be performed, for example, as follows. Let LLR set 322 have the following p₁ LLR values: (L₁, L₂, . . . , Lᵣ, Lᵣ₊₁, Lᵣ₊₂, . . . , L₂ᵣ₊₁, L₂ᵣ₊₂, L₂ᵣ₊₃, . . . , Lₚ₁), where p₁/(r+1)=p/r. Then, after the soft MTR decoding, the corresponding LLR set 222 has the following p LLR values: (L₁, L₂, . . . , Lᵣ, Lᵣ₊₂, . . . , L₂ᵣ₊₁, L₂ᵣ₊₃, . . . , Lₚ₁).

For non-binary codewords, the soft MTR decoding of step 404 can be performed, for example, as follows.

Let us assume that the constellation of available symbols consists of 2^{m} symbols u, where m is a positive integer greater than one. This means that each symbol u can be represented by a bit block consisting of m bits. A sequence of N symbols u is therefore represented by a corresponding sequence having N×m bits. When an MTR(r) code is applied to this sequence, it inserts into it one MTR bit per r original bits. Depending on the concrete values of m and r, a situation is possible in which different bit blocks representing different respective symbols u receive different numbers of MTR bits (if any).

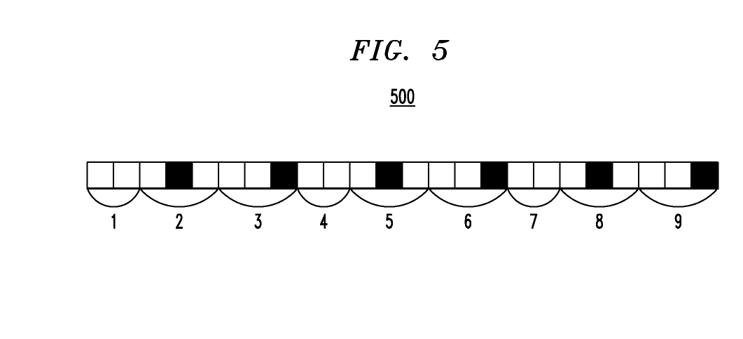

FIG. 5 shows an example corresponding to m=2 and r=3. More specifically, FIG. 5 shows an MTR-encoded bit sequence 500 having nine two-bit symbols u labeled 1-9. Each two-bit symbols u is represented in sequence 500 by two corresponding symbol bits shown in FIG. 5 as unfilled squares. The MTR(3) encoding has added one MTR bit per three symbol bits, which has inserted additional bits into some, but not all, of the nine two-bit symbols u, as indicated by the filled squares in FIG. 5, with each filled square representing a respective MTR bit. For example, each of the first, fourth, and seventh symbols u in sequence 500 does not have an MTR bit. In contrast, each of the second, fifth, sixth, eighth, and ninth symbols u in sequence 500 does have an MTR bit.

An LLR set (such as LLR set 322, FIG. 3) corresponding to an MTR-encoded bit sequence from a non-binary codeword has a property similar to that of sequence 500. Namely, some LLR blocks representing symbols u may not have any LLR values corresponding to MTR bits. To take this characteristic into account at step 404 of method 400, decoder 330 is configured to use one subroutine for applying soft MTR decoding to LLR blocks that have an LLR value corresponding to an MTR bit and a different subroutine for applying soft MTR decoding to LLR blocks that do not have an LLR value corresponding to an MTR bit.

In one embodiment, for an LLR block in LLR set 322 not having an LLR value corresponding to an MTR bit, decoder 330 is configured to calculate LLR values for LLR set 222 using a subroutine that implements Eq. (1):

$${L}_{i} ( u ) = {{max}^{*}}_{P ∈ {Δ}_{l , m}^{i}} [ {α}_{l} ( b ( P ) ) + {γ}_{l} ( P ) + {β}_{l + m} ( e ( P ) ] - {{max}^{*}}_{P ∈ {Δ}_{l , m}^{0}} [ {α}_{l} ( b ( P ) ) + {γ}_{l} ( P ) + {β}_{l + m} ( e ( P ) ) ] \qquad ( 1 )$$

with the various symbols in this equation denoting the following quantities:
Lᵢ(u) an i-th LLR value corresponding to symbol u. For an m-bit symbol u, there are LLR values. By convention, Lₒ(u)=0;
i an index pointing at different possible values (constellation points) for symbol u, where i {0, 1, 2, . . . , 2^{m}−1};
max* the Jacobi logarithm taken over the finite field defined in the underscript. In some literature, the Jacobi logarithm is referred to as the Zech logarithm;
P a path in the trellis of the LDPC code;
Δⁱ_{l,m} a set of paths P defined as Δⁱ_{l,m}={P=(s₀, s₁), (s₁, s₂), . . . , (sₘ₋₁, sₘ): sⱼ Sₗ₊ⱼ; j {0, 1, 2, . . . , m}; n(P)=i}, where (sₖ, sₖ₊₁) denotes an edge in the trellis that connects encoder states in two adjacent stages of the trellis; Sₗ₊ⱼ is the set of encoder states in the (l+j)-th stage of the trellis; lis an index pointing at the position in LLR set 322 corresponding to the first bit of symbol u; and n(P) is a topological metric of path P. More specifically, regarding n(P), it should be noted that in the trellis of a Viterbi algorithm, each edge leaving an encoder state can be assigned a value that depends on the end encoder state of that edge in the next stage. The sequence of these values describing path P and interpreted as an integer is n(P);
b(P) the encoder state at which path P begins;
e(P) the encoder state at which path P ends;
αₗ(b(P)) branch metric of the forward recursion of the Viterbi algorithm from state b(P);
βₗ₊ₘ(e(P)) branch metric of the backward recursion of the Viterbi algorithm from state b(P); and
γₗ(P) branch metric of path P, which is calculated as

$${γ}_{l} ( P ) = {\sum }_{i = 0}^{m - 1} {γ}_{l + i} ( {s}_{i} , {s}_{i + 1} ) ,$$

where γₗ₊ᵢ(sᵢ, sᵢ₊₁) is the branch metric of the transition in path P from encoder state sᵢ to encoder state sᵢ₊₁.

For an LLR block in LLR set 322 having an LLR value corresponding to an MTR bit, decoder 330 is configured to calculate LLR values for LLR set 222 using a subroutine that implements Eq. (2):

$${L}_{i} ( u ) = {{max}^{*}}_{P ∈ {Δ}_{l , m + 1}^{w ( i , q )}} [ {α}_{l} ( b ( P ) ) + {γ}_{l} ( P ) + {β}_{l + m + 1} ( e ( P ) ] - {{max}^{*}}_{P ∈ {Δ}_{l , m + 1}^{0}} [ {α}_{l} ( b ( P ) ) + {γ}_{l} ( P ) + {β}_{l + m + 1} ( e ( P ) ) ] \qquad ( 2 )$$

Most of the symbols used in Eq. (2) are already explained above in reference to Eq. (1). An index change in the β terms of Eq. (2) compared to the β terms of Eq. (1) is self-explanatory. The finite field in the underscript of the Jacobi logarithms has the following new quantity:
w(i,q) an (m+1)-bit value in which the q-th bit of i is repeated. More specifically, if the m-bit value i=a₀a₁ . . . a_{q}a_{q+1} . . . aₘ₋₁, then w(i,q)=a₀a₁ . . . a_{q}a_{q}a_{q+1} . . . aₘ₋₁.
   Also note, that branch metric γₗ(P) in Eq. (2) is calculated over a longer path P, which now contains m+1 states instead of m.

Referring again to FIG. 4, step 406 serves to activate the feedback-path branch in module 300 having encoder 340 and multiplexer 350 (see FIG. 3). Recall that the feedback path is used in the receiver, such as receiver 200 (FIG. 2), when the LDPC decoder requests a global iteration by sending a modified LLR word 262 back to the sequence detector. After being processed in de-multiplexer 270 and de-interleavers 236 and 238, LLR word 262 is presented to module 300 in the form of LLR sets 226 and 228. If LLR word 262 is received from the decoder, then step 406 directs the processing of method 400 to step 408. Otherwise, step 406 directs the processing of method 400 back to step 402.

At step 408, encoder 330 is configured to apply soft MTR encoding, using the MTR(r) code, to LLR set 226 corresponding to the LLR word 262 of step 406. In the description of FIG. 3, the LLR set generated after soft MTR encoding of LLR set 226 is LLR set 346.

For binary codewords, the soft MTR encoding of step 408 can be performed, for example, as follows. Let LLR set 226 have the following LLR values: (L₁, L₂, . . . , Lᵣ, Lᵣ₊₁, Lᵣ₊₂, . . . , L₂ᵣ, L₂ᵣ₊₁, L₂ᵣ₊₂, . . . , Lₚ). Then, after the soft MTR encoding, the corresponding LLR set 346 has the following LLR values: (L₁, L₂, . . . , Lᵣ, Lᵣ, Lᵣ₊₁, Lᵣ₊₂, . . . , L₂ᵣ, L₂ᵣ, L₂ᵣ₊₁, L₂ᵣ₊₂, . . . , Lₚ).

For non-binary codewords, the soft MTR encoding of step 408 can be performed, for example, as follows.

If, for each m-bit symbol u, LLR set 226 has M=2^{m}−1 LLR values (L₁, L₂, . . . , L_{M}), then the corresponding LLR set 346 has the following LLR values (L′₁, L′₂, . . . , L′ᵣ, L′ᵣ, L′ᵣ₊₁, L′ᵣ₊₂, . . . , L′₂ᵣ, L′₂ᵣ, L′₂ᵣ₊₁, L′₂ᵣ₊₂, . . . , L′ₚ), where the various L′ values are the LLR values corresponding to the individual bits of symbol u.

In one embodiment, encoder 340 is configured to calculate LLR values L′ᵢ using a subroutine that implements Eq. (3):

$${L}_{i}^{′} = {{max}_{j ∈ {Ω}_{i}^{1}}}^{*} {L}_{j} ( u ) - {{max}_{j ∈ {Ω}_{i}^{0}}}^{*} {L}_{j} ( u ) \qquad ( 3 )$$

with the various symbols in this equation denoting the following quantities:
Lⱼ(u) the j-th LLR value corresponding to symbol u. For an m-bit symbol u, there are 2^{m} LLR values. By convention, L₀(u)=0;
i an index pointing at different individual bits of symbol u, where i {0, 1, 2, . . . , m−1};
j an index pointing at different possible values for symbol u, where j {0, 1, 2, . . . , 2^{m}−1}; and
Ω^{q}ᵢ a set of values defined as Ω^{q}ᵢ={j: V(j,i)=q}, where V(j,i)=(j/2ⁱ) mod 2, and q is either 0 or 1. Note that function V(j,i) returns the value of the i-th bit of j.

At step 410, sequence detector 310 is configured to generate LLR word 312 based on LLR word 352 instead of digital signal 212 (as in step 402). LLR word 352 used in step 410 is generated by multiplexer 350 using LLR set 346 generated at step 408 and LLR set 228 received at step 406. After the completion of step 410, the processing of method 400 is directed back to step 402.

While this invention has been described with reference to embodiments, this description is not intended to be construed in a limiting sense.

Unless explicitly stated otherwise, each numerical value and range should be interpreted as being approximate as if the word “about” or “approximately” preceded the value of the value or range.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence.

The use of figure numbers and/or figure reference labels in the claims is intended to identify one or more possible embodiments of the claimed subject matter in order to facilitate the interpretation of the claims during the examination. Such use is not to be construed as necessarily limiting the scope of those claims to the embodiments indicated by the used figure numbers and/or figure reference labels.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments.

Also for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements.

Embodiments of the invention can be manifest in other specific apparatus and/or methods. The described embodiments are to be considered in all respects as only illustrative and not restrictive. All changes that come within the meaning and range of equivalency of the claims are to be embraced within their scope.

A person of ordinary skill in the art would readily recognize that steps of various above-described methods can be performed by programmed computers. Herein, some embodiments are intended to cover program storage devices, e.g., digital data storage media, which are machine or computer readable and encode machine-executable or computer-executable programs of instructions where said instructions perform some or all of the steps of the methods described herein. The program storage devices may be, e.g., digital memories, magnetic storage media, such as magnetic disks or tapes, hard drives, or optically readable digital data storage media. The embodiments are also intended to cover computers programmed to perform said steps of methods described herein.

The description and drawings merely illustrate embodiments of the invention. Furthermore, all examples recited herein are principally intended expressly to be only for pedagogical purposes to aid the reader in understanding an embodiment of the invention and the concepts contributed by the inventor(s) to furthering the art, and are to be construed as being without limitation to such specifically recited examples and conditions. Moreover, all statements herein reciting embodiments of the invention, as well as specific examples thereof, are intended to encompass equivalents thereof.

The functions of the various elements shown in the figures, including any functional blocks labeled as “processors,” may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “computer,” “processor,” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM), and non volatile storage. Other hardware, conventional and/or custom, may also be included.

It should be appreciated by those of ordinary skill in the art that any block diagrams herein represent conceptual views of circuitry representing one of more embodiments of the invention. Similarly, it will be appreciated that any flowcharts, flow diagrams, state transition diagrams, pseudo code, and the like represent various processes which may be substantially represented in computer readable medium and so executed by a computer or processor, whether or not such computer or processor is explicitly shown.

Although embodiments of the invention have been described herein with reference to the accompanying drawings, it is to be understood that embodiments of the invention are not limited to the described embodiments, and one of ordinary skill in the art will be able to contemplate various other embodiments of the invention within the scope of the following claims.

Although some portions of the detailed description have been presented in terms of algorithms and symbolic representations of operations on data bits, these algorithmic descriptions and representations are the means used by those of ordinary skill in the arts of data processing to most effectively convey the substance of their work to others. It has proven convenient at times, principally for reasons of common usage, to refer to some signals as bits, words, values, elements, symbols, characters, numbers, or the like. It should be born in mind, however, that all of these and similar terms are associated with tangible physical quantities and are merely convenient labels intended to refer to those physical quantities. Unless specifically stated otherwise, as apparent from the detailed description, it should be appreciated that the terms such as processing, computing, calculating, determining, displaying, and the like refer to actions and processes of a machine, computer system, or electronic circuit configured to manipulate and transform a first set of data represented as physical quantities within registers and/or memory elements into a second (possibly different) set of data similarly represented as physical quantities within registers and/or memory elements.

What is claimed is:

1. An apparatus comprising:
a parity encoder (e.g., 130) configured to apply a parity-check code to generate a stream of parity bits (e.g., 132) based on an input data stream (e.g., 112);
an inner modulation encoder (e.g., 150) configured to apply an inner modulation code to generate a first encoded data stream (e.g., 152) based on the stream of parity bits; and
a multiplexer (e.g., 160) configured to multiplex the first encoded data stream and the input data stream to generate a sequence of codewords corresponding to the input data stream.

2. The apparatus of claim 1, further comprising a signal generator (e.g., 170) configured to convert the sequence of codewords into an output communication signal and apply said output communication signal to a communication channel.

3. The apparatus of claim 1, further comprising an outer modulation encoder (e.g., 110) configured to apply an outer modulation code to a source data stream (e.g., 102) to generate the input data stream.

4. The apparatus of claim 3, wherein:
the outer modulation code is a run-length-limited code or a maximum-transition-run code; and
the inner modulation code is a maximum-transition-run code.

5. The apparatus of claim 3, wherein:
the outer modulation code is a first maximum-transition-run code; and
the inner modulation code is a second maximum-transition-run code that is different from the first maximum-transition-run code.

6. The apparatus of claim 1, wherein the parity-check code is a non-binary low-density parity-check code.

7. The apparatus of claim 1, further comprising:
a first interleaver (e.g., 120) configured to interleave the input data stream and apply a resulting interleaved data stream (e.g., 122) to the parity encoder, wherein the parity encoder is configured to apply the parity-check code to said resulting interleaved data stream to generate the stream of parity bits; and
a second interleaver (e.g., 140) configured to de-interleave the stream of parity bits and apply a resulting de-interleaved stream of parity bits (e.g., 142) to the inner modulation encoder, wherein the inner modulation encoder is configured to apply the inner modulation code to said resulting de-interleaved stream of parity bits to generate the first encoded data stream.

8. The apparatus of claim 7, wherein the second interleaver is configured to de-interleave the stream of parity bits in a manner that causes the de-interleaved stream of parity bits to be independent of bit reordering performed in the first interleaver.

9. An apparatus comprising:
a detector module (e.g., 220) configured to generate log-likelihood-ratio values for a first log-likelihood-ratio word (e.g., 252) based on an input signal (e.g., 212) and using an inner modulation code, with the detector module being configured to apply the inner modulation code in a log-likelihood-ratio space; and
a parity-check decoder (e.g., 260) configured to apply parity-check-based decoding to the first log-likelihood-ratio word to enable the apparatus to recover information bits encoded in the input signal.

10. The apparatus of claim 9, wherein the parity-check decoder is configured to (i) apply said parity-check-based decoding to the first log-likelihood-ratio word to generate a second log-likelihood-ratio word (e.g., 262) and (ii) direct the second log-likelihood-ratio word to the detector module to enable decoding iterations between the detector module and the parity-check decoder.

11. The apparatus of claim 10, further comprising:
a hard-decision filter (e.g., 280) configured to remove magnitude bits from a first set (e.g., 228) of log-likelihood-ratio values of the second log-likelihood-ratio word to generate a corresponding modulation-encoded word (e.g., 282), wherein said first set of the log-likelihood-ratio values represents the information bits encoded in the input signal; and
an outer modulation decoder configured to apply an outer modulation code to the modulation-encoded word to recover said information bits.

12. The apparatus of claim 11, wherein the outer modulation code is a run-length-limited code or a maximum-transition-run code.

13. The apparatus of claim 11, wherein:
the outer modulation code is a first maximum-transition-run code; and
the inner modulation code is a second maximum-transition-run code that is different from the first maximum-transition-run code.

14. The apparatus of claim 9, further comprising a front-end circuit configured to generate the input signal based on an input communication signal received from a communication channel.

15. The apparatus of claim 14, further comprising a transmitter coupled to the communication channel and configured to cause the front-end circuit to receive the input communication signal.

16. The apparatus of claim 15, wherein the transmitter comprises:
a parity encoder (e.g., 130) configured to apply a parity-check code to generate a stream of parity bits (e.g., 132) based on an input data stream (e.g., 112);
an inner modulation encoder (e.g., 150) configured to apply the inner modulation code to generate a first encoded data stream (e.g., 152) based on the stream of parity bits; and
a multiplexer (e.g., 160) configured to multiplex the first encoded data stream and the input data stream to generate a sequence of codewords corresponding to the input data stream, wherein the input communication signal received by the front-end circuit from the communication channel represents the sequence of codewords generated by the multiplexer.

17. The apparatus of claim 9, wherein the parity-check-based decoding is based on a non-binary low-density parity-check code.

18. The apparatus of claim 9, further comprising a feedback path from the parity-check decoder to the detector module, wherein:
the parity-check decoder is configured to apply said parity-check-based decoding to the first log-likelihood-ratio word to generate a second log-likelihood-ratio word (e.g., 262); and
when the second log-likelihood-ratio word does not satisfy one or more parity checks of the parity-check-based decoding, the detector module is configured to regenerate log-likelihood-ratio values for the first log-likelihood-ratio word based on the second log-likelihood-ratio word received through the feedback path and using the inner modulation code.

19. The apparatus of claim 18,
wherein the detector module comprises:
a soft modulation encoder (e.g., 340) configured to apply the inner modulation code to a second set (e.g., 226) of log-likelihood-ratio values of the second log-likelihood-ratio word to generate a third set (e.g., 346) of log-likelihood-ratio values, wherein said second set of the log-likelihood-ratio values represents parity bits of a corresponding codeword encoded in the input signal;
a sequence detector (e.g., 310) configured to generate a third log-likelihood-ratio word (e.g., 312) either based on the input signal or based on the first and third sets of the log-likelihood-ratio values; and
a soft modulation decoder (e.g., 330) configured to apply the inner modulation code to a fourth set (e.g., 322) of log-likelihood-ratio values to generate a fifth set (e.g., 222) of log-likelihood-ratio values, wherein the third log-likelihood-ratio word comprises the fourth set of the log-likelihood-ratio values, which fourth set represents parity bits of the corresponding codeword encoded in the input signal; and
wherein the first log-likelihood-ratio word comprises the fifth set of the log-likelihood-ratio values and a sixths set (e.g., 224) of log-likelihood-ratio values, wherein the third log-likelihood-ratio word further comprises the sixth set of the log-likelihood-ratio values, which sixth set represents information bits of the corresponding codeword encoded in the input signal.

20. The apparatus of claim 19, further comprising:
a first interleaver (e.g., 232) configured to apply a first interleaving operation to the fifth set of the log-likelihood-ratio values to cause the first log-likelihood-ratio word to have the log-likelihood-ratio values of the fifth set in a corresponding interleaved order;
a second interleaver (e.g., 234) configured to apply a second interleaving operation to the sixth set of the log-likelihood-ratio values to cause the first log-likelihood-ratio word to have the log-likelihood-ratio values of the sixth set in a corresponding interleaved order;
a third interleaver (e.g., 236) configured to cause the second set (e.g., 226) of the log-likelihood-ratio values to be independent of the first interleaving operation; and
a fourth interleaver (e.g., 238) configured to cause the first set (e.g., 228) of the log-likelihood-ratio values to be independent of the second interleaving operation.
